(19) United States
(12) Patent Application Publication
(10) Pub. No.: US 2008/0318122 A1
(43) Pub. Date: Dec. 25, 2008

(54) LARGE FORMAT LITHIUM-ION CELL AND ITS USES THEREOF

(76) Inventor: Luying Sun, Randolph, NJ (US)

Correspondence Address: Diane Dunn McKay;Mathews, Shepherd, McKay & Bruneau, P.A., Suite 201, 29 Thanet Road, Princeton, NJ, 08540, US

(21) Appl. No.: 12/131,619

(22) Filed: Jun. 2, 2008

Related U.S. Application Data
(60) Provisional application No. 60/932,729, filed on Jun. 2, 2007.

(51) Int. Cl. H01M 6/42; H01M 6/00; H01M 2/02; H01M 6/14; H01M 2/16

(52) U.S. Cl. 429/156; 29/623.1; 429/176; 429/344; 429/246

(57) ABSTRACT

This invention is directed to a battery pack with a high energy density and a large format prismatic lithium-ion cell comprising (1) at least one positive electrode, (2) at least one negative electrode, (3) a non-aqueous electrolyte, and (4) a homogeneous microporous membrane which comprises (a) a hot-melt adhesive, (b) an engineering plastics, (c) optionally a tackifier and (d) a filler having an average particle size of less than about 50 μm. The resulting battery pack can be used as power source for applications such as electric vehicles (EV), hybrid electric vehicles (HEV), power-assist HEV (P-HEV), and standby power stations.

### CROSS REFERENCE TO RELATED APPLICATION

This application claims priority to U.S. provisional application No. 60/932,729 filed Jun. 2, 2007, the disclosure of this application is hereby incorporated by reference in its entirety.

### STATEMENT OF GOVERNMENT FUNDED RESEARCH

This invention was supported by U.S. special operations contract number H92222-05-C-0035 with Government support. The Government has certain rights in the invention.

### FIELD OF THE INVENTION

This invention relates generally to battery packs and electrochemical cells with high energy density and methods of making the battery pack and large format prismatic lithium-ion cells.

### BACKGROUND OF THE INVENTION

Lithium-ion cell/battery have been used as the power source for many applications, such as cellular phones and notebook computers. However, the lack of technology for making cells in large format and for making the cells safe have prevented the introduction of lithium-ion cell into large format systems such as electric vehicles (EV), hybrid electric vehicles (HEV), and standby power stations. There is a need to develop large format battery cells and battery packs with high energy density.

### BRIEF SUMMARY OF THE INVENTION

One aspect of the invention is directed to a battery pack comprising two or more large format prismatic lithium-ion cells with a specific energy of greater than 200 Wh/kg which comprise (a) at least one positive electrode, (b) at least one negative electrode, (c) an electrolyte, (d) a homogeneous microporous membrane which comprises (i) a hot-melt adhesive, (ii) an engineering plastics, (iii) optionally a tackifier and (iii) a filler having an average particle size of less than about 50 μm, and (5) a battery cell case.

Another aspect of the invention is directed to a large format prismatic lithium-ion cell comprising (1) at least one positive electrode, (2) at least one negative electrode, (3) an electrolyte, (4) a homogeneous microporous membrane which comprises (a) a hot-melt adhesive, (b) an engineering plastics, (c) optionally a tackifier and (d) a filler having an average particle size of less than about 50 μm, and (5) a battery cell case.

A further aspect of the invention is directed to a method of making the large format prismatic lithium-ion cell, comprising the steps of (a) assembling cell by sandwiching at least a separator membrane between at least a positive electrode and at least a negative electrode, (b) binding separator membranes onto electrodes by pressing under a pressure of 50-250 psi (3.5-17.4 kg/cm²) at a temperature from 80-100° C. and for about 1-10 minutes, (c) packaging the cell assembly into a battery cell case, (d) injecting an electrolyte into the case.

The contents of the patents and publications cited herein and the contents of documents cited in these patents and publications are hereby incorporated herein by reference to the extent permitted.

### BRIEF DESCRIPTION OF THE DRAWINGS

FIG. 1 is top plan view of a large format prismatic lithium-ion cell of this invention.

FIG. 2 is an end view of the cell shown in FIG. 1.

FIG. 3 is a graph showing the discharge profile of cell No. E-04 when discharged at a constant current of 1.0 A to a cut-off voltage of 2.5V.

FIG. 4 shows the charge (solid line) and discharge profiles (line with circle) of one section of the battery pack, No. E-06.

### DETAILED DESCRIPTION

The large format prismatic lithium-ion cells of this invention have key advantages over conventional prismatic or cylindrical cells. They have not only a higher energy density and specific energy, but also a substantially lower possibility of battery failure due to a “hot” cell problem when the cells are used for assembling battery packs. They also have improved safety features such as a lower thermal shut-down temperature.

In a preferred embodiment, the battery or battery pack is made by assembling several large format prismatic lithium-ion cells in series to add up voltage, or in parallel to increase capacity. For instance, when two lithium-ion cells, each having a 3.7V and a capacity of 4.5 Ah, are assembled together in series, the resulting battery has a doubled voltage (7.2V) and a same capacity of 4.5 Ah. If these two cells are assembled in parallel, the resulting battery has a double capacity (9.0 Ah) and a same voltage of 3.7V.

In one preferred embodiment of the battery pack, the large format prismatic lithium-ion cell has a footprint of at least 4×4 inches, preferably between 4×4 inches and 24×24 inches. Preferably, the battery cell case is made of aluminum foil-laminated plastic film, the positive electrode is a lithium-ion positive electrode, the negative electrode is a lithium-ion negative electrode and the electrolyte is a lithium-ion electrolyte, more preferably a liquid lithium-ion electrolyte or a polymer lithium-ion electrolyte.

The negative electrode is usually made of carboneous material such as coke, MCMB, or graphite. The positive electrode can be made of lithium compounds such as LiCoO₂, LiNiO₂, LiMn₂O₄, LiFePO₄, and LiCoₓNi₁₋ₓO₂ wherein the x is from 0.1 to 0.9. However, any electrode materials known in the art can be used herein.

The liquid lithium-ion electrolyte is preferably a non-aqueous electrolyte, which usually comprises: (1) an electrolyte salt, and (2) a non-aqueous solvent. Examples of these electrolyte salts include LiPF₆, LiBF₄, LiAsF₆, LiCl4, LiN(SO₂CF₃)₂, and lithium perfluoro-sulfonates. Examples of non-aqueous solvent is include ethylene carbonate “EC”, propylene carbonate “PC”, diethyl carbonate “DEC”, dimethyl carbonate “DMC”, ethyl methyl carbonate “EMC”, γ-butyrolactone “γ-BL”, methyl acetate “MA”, methyl formate “MF”, and dimethyl ether “DME”, and solvents described in U.S. Pat. Appl. Publication No. 20050123835, published on Jun. 9, 2005, to Sun, the contents of which are incorporated herein by reference to the extent permitted.

The positive electrode and the negative electrode are separated by at least one heat-activatable microporous membrane as described in U.S. Pat. Nos. 6,527,955, Mar. 4, 2003; 6,998,193, Feb. 14, 2006, to Sun, the contents of which are incorporated herein by reference.

In another preferred embodiment, the large format prismatic lithium-ion cell has a thickness of from about 1 mm to about 10 mm. Preferably, the large format prismatic lithium-ion cell has a specific energy of greater than 200 Wh/kg, more preferably greater than 210 Wh/kg and the most preferably about 220 Wh/kg.

In another embodiment, the large format prismatic lithium-ion cell has an energy density of at least 450 Wh/L, preferably at least 500 Wh/L, more preferably at least 510 Wh/L and the most preferably at least 520 Wh/L.

As used herein, the terms “separator membrane”, “bondable separator membrane”, “heat-activatable microporous membrane”, and “homogeneous microporous membrane” are used interchangeably.

As used herein, the term “cell” or “battery cell” means an electrochemical cell made of at least one positive electrode, at least one negative electrode, an electrolyte, and a separator membrane. The term “cell” and “battery cell” are used interchangeably. The “battery” or “battery pack” means an electric storage device made of more than two cells. The terms “battery” and “battery pack” are used interchangeably.

The battery cell case is preferably made with aluminum foil-laminated plastic film or sheet, which has a thickness of from about 20 μm to about 200 μm. More preferably, the aluminum foil-laminated plastic film has a thickness of from about 30 μm to about 100 μm. Most preferably, aluminum foil-laminated plastic film has a thickness of from about 40 μm to about 50 μm.

Preferably, the large format prismatic lithium-ion cell has a width of from about 4 inches to about 24 inches. More preferably, the cell has a width of from about 4 inches to about 10 inches.

Preferably, the large format prismatic lithium-ion cell has a length of from about 4 inches to about 24 inches. More preferably, the cell has a length of from about 4 inches to about 12 inches.

In a preferred embodiment, the large format prismatic lithium-ion cell of this invention has a thickness of from about 1 mm to about 10 mm. More preferably, the cell has a thickness of from about 3 mm to about 6 mm.

In another preferred embodiment, the binding of separator membranes onto electrodes is achieved by pressing under a pressure of from 50 to about 250 psi (3.5-17.4 kg/cm²) at a temperature of from about 60 to about 125° C. for a period of about 0.1-100 minutes, preferably from about 1 to about 10 minutes.

An important utility for the large format prismatic lithium-ion cell is in the assembly of large battery packs to be used as the power source for applications such as electric vehicles (EV), hybrid electric vehicles (HEV), power-assist HEV (P-HEV), and standby power stations.

A large format prismatic cell offers a high energy density and has the advantage of less battery (pack) failure due to a “hot cell”. A battery pack is usually assembled with many cells in series as well as in parallel. In case one cell has a problem such as lower capacity or higher internal resistance, the whole battery pack becomes bad, which may no longer be used. The problem cell is the so-called “hot cell”.

Table 1 gives an example for assembling 42V/700 Wh battery for power-assist HEV (P-HEV) application using three types of lithium-ion cells. These are 1) 18650 cylindrical cells which have been widely used for making battery packs to power notebook computers, 2) a prismatic cell with a footprint of 4 by 4 inches, made by Policell Technologies, and 3) a prismatic cell with a even larger footprint, 8×11 inches, namely “Letter” paper size.

As shown in table 1, 84 pieces of 18650 cylindrical cells are needed to assemble one 42V battery with energy of about 700 Wh. The number of cells needed for making one of this 42V battery reduces to 48 if cells with a footprint of 4 by 4 inches are used. With the use of cells of 8 by 11 inches, only 12 cells are needed to assemble one 42V battery.

If we use the possibility of battery failure for the battery assembled with cells of 8 by 11 inches as the comparison and assign it a number 1, the possibility of failure due to a “hot” cells for the 4″ by 4″ cells and the 18650 cylindrical cells would be 4 and 7, respectfully.

TABLE 1

| | | | | | No. of cells | |
|---|---|---|---|---|---|---|
| | | Footprint | Thickness | Capacity/ | for a 42 V/ | Possibility |
| | Cell config- | of cell | of cell | Energy | 700 Wh | of battery |
| Type of cell | uration | (inch) | (mm) | (Ah/Wh) | battery | failure |
| 18650 | cylindrical | Length: | Φ18 mm | 2.4/8.9 | 84 | 7 |
| | | 65 mm | | | | |
| PLB33105100 | prismatic | 4″ × 4″ | 3.3 | 4.7/17.4 | 48 | 4 |
| PLB33216280 | prismatic | 8″ × 11″ | 3.3 | 27.5/101.8 | 12 | 1 |
| | | | | (projected) | | |

The following examples are given as specific illustrations of the invention. It should be understood, however, that the invention is not limited to the specific details set forth in the examples. All parts and percentages in the examples, as well as in the remainder of the specification, are by weight unless otherwise specified.

Further, any range of numbers recited in the specification or paragraphs hereinafter describing or claiming various aspects of the invention, such as that representing a particular set of properties, units of measure, conditions, physical states or percentages, is intended to literally incorporate expressly herein by reference or otherwise, any number falling within such range, including any subset of numbers or ranges subsumed within any range so recited. The term “about” when used as a modifier for, or in conjunction with, a variable, is intended to convey that the numbers and ranges disclosed herein are flexible and that practice of the present invention by those skilled in the art using temperatures, concentrations, amounts, contents, carbon numbers, and properties that are outside of the range or different from a single value, will achieve the desired result, namely, a microporous membrane and method for preparing such membranes as well as a battery comprising the membrane.

### EXAMPLE 1

### Cell Preparation and Testing

A large format prismatic lithium-ion cell was assembled using a graphite negative electrode, a LiCoO₂ positive electrode, and a bondable separator membrane. Into the assembled battery cell case, was then injected an electrolyte. Both negative and positive electrodes were conventional liquid lithium-ion battery electrodes, namely negative and positive materials are double-side coated onto copper and aluminum foil respectively, the carbon negative electrode containing about 90% graphite active material, the LiCoO₂ positive electrode containing about 91% active material.

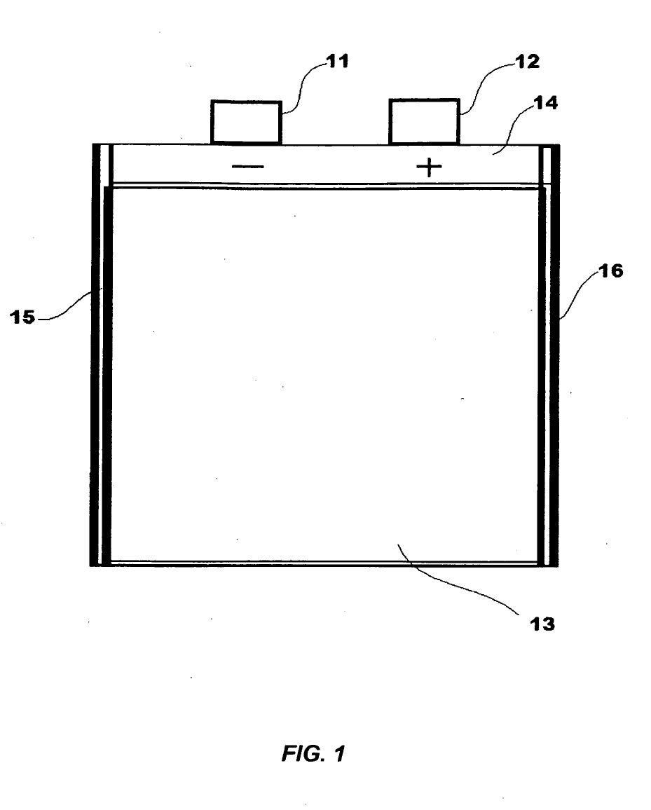

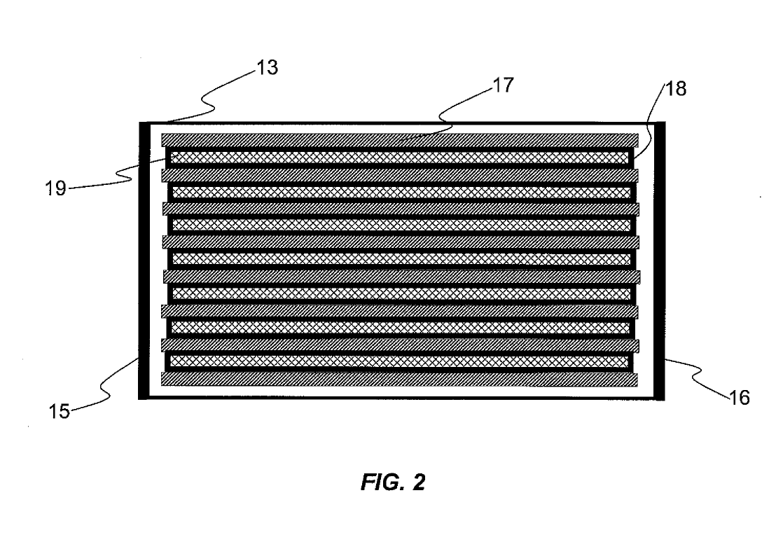

A large format prismatic lithium-ion cell, Cell No. E-01, was assembled as shown in FIG. 1 and FIG. 2 by, a) wrapping seven pieces positive electrode 19 having a size of 90 mm by 99 mm with a bondable separator membrane 18 with a dimension of 94 mm by 202 mm, b) stacking these seven pieces separator wrapped positive electrodes and eight pieces negative electrodes 17 having a size of 93 mm by 102 mm starting with negative electrode on bottom first then separator wrapped positive electrode, 2^{nd} negative and 2^{nd} positive in this alternative sequence, and ended with the 8^{th} negative electrode on top.

The resulting stacked cell assembly was then subjected to a step of heat-activation by pressing at 100° C. under a pressure of 109 psi for 3 minutes. After such a “dry-press” step, separator membranes bound onto electrodes firmly and the cell assembly became a stiff single piece.

These eight negative electrode leads were welded to a negative cell terminal 11 made of copper foil with a size of 10 mm by 40 mm, while seven positive electrode leads were welded to a positive cell terminal 12, which was made of aluminum foil 10 mm by 40 mm.

The cell assembly was then packaged in a cold-formed battery cell case 13, which was made with aluminum foil-laminated plastic film produced by Dai Nippon Printing Co. of Shinjuku-ku, Tokyo, Japan. Then sealed terminal side 14 and one side 15 of the cell case using a heat sealer. After the cell was fully dried, it was transferred into a dry-box under nitrogen atmosphere. Substantially about 14 g of electrolyte were injected into the cell. The cell was finally hermetically sealed by heat-sealing the last open side 16, rested for one day, and then subjected to charge/discharge cycle test. The charge/discharge cycle test was conducted using a Battery Tester Model Series 4000 manufactured by Maccor Inc. of Tulsa, Okla. Data concerning this large format cell, cell #E-01, are set forth in Table 2.

This cell delivered a discharge capacity of 3,657.4 mAh. The cell has an external dimension of 105 mm by 100 mm, i.e. about 4 by 4 inches.

### COMPARATIVE EXAMPLE 1

This example is shown in Table 2, Cell No. CE-1, which was prepared using the same materials and the same procedure as described in Example 1 except skipping the “dry-press” step. Without the “dry-press” step for binding separators onto electrodes, the resulting cell assembly was lose rather than a stiff single piece as Example E-01. To hold the cell assembly #CE-01 together, Kapton® adhesive tapes were used to wrap the cell assembly twice at the head and foot positions.

The testing results of this cell, No. CE-01, are set forth in Table 2. The cell showed a capacity of 3,188.3 mAh, which is 12.8% lower than that of Cell No. E-01, and also showed lower rate capability (83.9% vs. 96.4%) because its poor interface between separator membranes and electrodes.

TABLE 2

| | | Discharge | Rate capability |
|---|---|---|---|
| | ‘Dry-press’ | capacity | at 1C rate |
| Cell No. | (° C./psi/min.) | (mAh) | (%) |
| E-01 | 100/109/3 | 3,657.4 | 96.4 |
| CE-01 | none | 3,188.3 | 83.9 |

### EXAMPLES 2-5

As summarized in Table 3, four large format prismatic lithium-ion cells, Cell Nos. E-02 through E-05, were prepared in the same manner as described in Example 1 except using one additional pair of electrodes and also slightly larger electrodes.

Cells Nos. E-02 through E-05 were assembled with 8 units/pairs of basic cells: 8 double-side coated positive electrode 91 mm by 100 mm, 7 double-side coated negative electrodes 94 mm by 103 mm, and 2 single-side coated negative electrodes which were assembled on the top and bottom of the cell.

Testing results of these four cells are summarized in Table 3 including discharge capacity, weight of cells, specific energy, and energy density.

All these fours cells have the same external dimension of 3.3 (Thickness)×105 (Width)×100 mm (Length), namely the cells with a footprint of about 4 by 4 inches. They delivered a capacity of about 4.8 Ah when discharged at a constant current of 1,000 mA to a cut-off voltage of 2.5V.

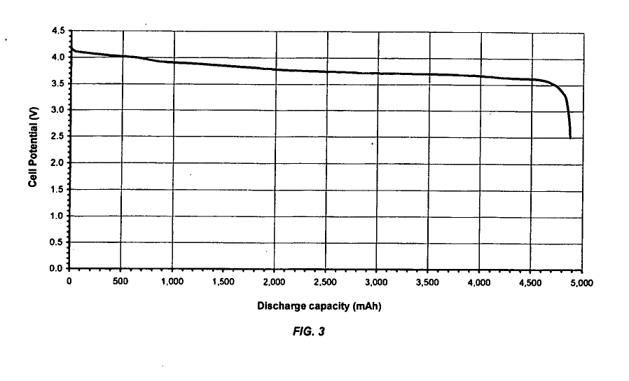

FIG. 3 shows discharge profile of cell No. E-04 when discharged at a constant current of 1,000 mA to a cut off voltage of 2.5V.

These cells Nos. E-02 through E-05 showed a specific energy of 214-219 Wh/kg and an energy density of about 520 Wh/L.

TABLE 3

| | Discharge | Weight | Specific | Energy |
|---|---|---|---|---|
| Cell No. | capacity (mAh) | of cells (g) | energy (Wh/kg) | density (Wh/L) |
| E-02 | 4,839.7 | 82.4 | 217.3 | 517.5 |
| E-03 | 4,790.4 | 82.6 | 214.6 | 512.3 |
| E-04 | 4,874.7 | 82.6 | 218.4 | 521.3 |
| E-05 | 4,889.7 | 82.6 | 219.0 | 522.9 |

### EXAMPLE 6

### Assembly of Battery Pack

Sixteen large format prismatic lithium-ion cells were made in the same manner as described in Examples 2-5. Then these sixteen cells were used to assemble one battery pack, No. E-06.

The battery pack consists of 2 sections or modules. Each section was assembled using 8 cells in the configuration of 4S2P, namely 4 cells in series, and the resulting 2 units made of 4 cells in series were then assembled in parallel.

The battery pack (No. E-06) weighs about 1.5 kg, and has an external dimension of 112.5×127.0×63.0 mm.

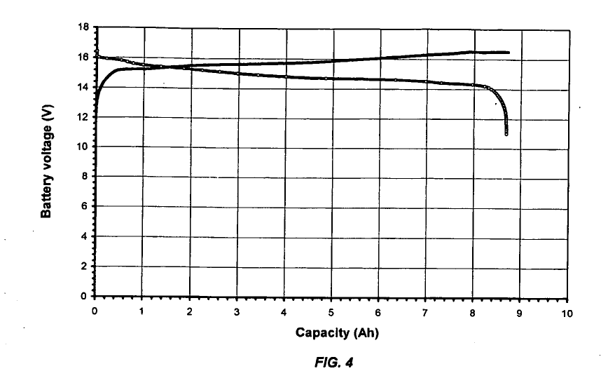

FIG. 4 shows the charge (solid line) and discharge profiles (line with circle) of one section (Section I) of the battery. Each section was made of 8 cells in the configuration of 4S2P. This section of the battery was charged at a constant current of 2.0 A up to 16.5V, and then charged continuously under constant voltage until the current dropped to below 0.3 A. It was then discharged at a constant current of 2.0 A down to a cut-off voltage of 11V.

This section of the battery delivered a discharge capacity of 8.69 Ah. The other section of this battery, Section II, showed the same capacity when charged and discharged in the same manner as for Section I.

These two sections of the battery can be operated independently or by combining them together. By combining the two sections in series, the battery offered a capacity of about 8.69 Ah with a doubled voltage of 28V (33-22V). While, by combining these two sections together in parallel, the battery delivered a doubled capacity (about 17.38 Ah) and with a voltage of 14V (16.5-1 IV).

When either Section I or Section II of the battery as described above was charged at a constant current of 2.0 A up to a cut-off voltage of 16.8V, namely 4.2V for each individual cell which has been widely used in the industry to fully charge cells, each section delivered a discharge capacity about 9.5 Ah. Since the battery has a weight of 1.5 kg and a volume of 0.9 liter, the specific energy and energy density of the battery are calculated to be 187.5 Wh/Kg and 312.4 Wh/L.

### EXAMPLE 7

### Assembly of Battery Pack for HEV

Seventy-eight large format prismatic lithium-ion cells with a footprint of 4 by 6 inches are prepared in the same manner as described in Examples 2-5 except using larger electrodes and separator membranes.

Each cell has a thickness of 3.3 mm, a size of 4 by 6 inches, and a weight of about 122 g. The cell delivers a discharge capacity of 7.0 Ah with a nominal voltage of 3.7V.

A battery pack, No. E-07, is made by assembling these 78 cells in series. As summarized in Table 4, the resulting battery pack will have a voltage of 288V and deliver a capacity of 7.0 Ah, i.e. will offer an energy of 2.0 kWh. The total weight of these 78 cells is 9.5 Kg. This battery pack can be used as power source for HEV. The characteristics of the battery used for Toyota Prius HEV are shown in the table for comparison. As shown, the battery pack of this invention offers higher energy while weighs much less than the nickel metal hydride “NiMH” battery used for Toyota Prius HEV, 9.5 kg vs. 43.2 kg. The weight is a total of cells only excluding electronic circuitries and other parts for power and heat managements.

TABLE 4

| | Lithium-ion | NiMH |
|---|---|---|
| Type of cells | 4″ × 6″ cells | D-size |
| Applications | HEV | Toyota Prius HEV |
| Cell voltage (V) | 3.7 | 1.2 |
| Cell capacity (Ah) | 7.0 | 6.5 |
| Cell size | 4″ × 6″ | Φ32.2 mm, H: 58.5 mm |
| Cell weight (g) | 122 | 180 |
| No. of cells per battery pack | 78 | 240 |
| Battery voltage (V) | 288 | 288 |
| Energy of battery (kWh) | 2.0 | 1.87 |
| Total Wt. of cells per | 9.5 | 43.2 |
| battery (kg) | | |

### EXAMPLE 8

### Assembly of 42V Battery Pack for P-HEV

Twelve large format prismatic lithium-ion cells with a footprint of 8×11 inches, i.e. “Letter” paper size, are made in the same manner as described in Examples 2-5 except using larger electrodes and larger separator membranes.

Each cell has a thickness of 3.3 mm, a size of 8×11 inches, and a weight of about 478 g. The cell delivers a discharge capacity of 27.5 Ah with a nominal voltage of 3.7V.

A battery pack, No. E-08, is made by assembling these 12 cells together in series. The resulting battery pack will have a voltage of 42V and deliver a capacity of 27.5 Ah, i.e. will offer an energy of 1,155 Wh. The total weight of these 12 cells is about 5.7 Kg. The battery pack can be used as power source for P-HEV.

### EXAMPLE 9

### Assembly of 40 kWh Battery Pack for EV

Four hundred large format prismatic lithium-ion cells with a footprint of 8×11 inches are made in the same manner as described in Example 8. Then these 400 cells are used to assemble one battery pack.

The battery pack, No. E-09, is assembled using above 400 cells in the configuration of 100S4P, namely 100 cells in series, and the resulting 4 groups made of 100 cells in series are then assembled in parallel.

The battery pack (No. E-09) will have a voltage of 370V and deliver a capacity of 110 Ah, i.e. will offer energy of 40.7 kWh. The total weight of these 400 cells is about 191 kg. If we use this battery pack to power a small sedan, the battery pack would be able to power the car for about 407 km, i.e. 254 miles before it needs a recharge. This driving distance is comparable with a similar size gasoline-driven automobile per each refuel.

The principles, preferred embodiments, and modes of operation of the present invention have been described in the foregoing specification. The invention which is intended to be protected herein, however, is not to be construed as limited to the particular forms disclosed, since these are to be regarded as illustrative rather than restrictive. Variations and changes may be made by those skilled in the art, without departing from the spirit of the invention.

What is claimed is:

1. A battery pack comprising two or more large format prismatic lithium-ion cells with a specific energy of greater than 200 Wh/kg which comprise
(a) at least one positive electrode,
(b) at least one negative electrode,
(c) electrolyte,
(d) a homogeneous microporous membrane which comprises
(i) a hot-melt adhesive,
(ii) an engineering plastics,
(iii) optionally a tackifier and
(iv) a filler having an average particle size of less than about 50 μm, and
(e) a battery cell case

2. The battery pack of claim, wherein said large format prismatic lithium-ion cell has a footprint of at least 4×4 inches.

3. The battery pack of claim 1, wherein said battery cell case is made of aluminum foil-laminated plastic film.

4. The battery pack of claim 1, wherein said at least one positive electrode is a lithium-ion positive electrode.

5. The battery pack of claim 1, wherein said at least one negative electrode is a lithium-ion negative electrode.

6. The battery pack of claim 1, wherein said electrolyte is a lithium-ion electrolyte.

7. The battery pack of claim 6, wherein the lithium-ion electrolyte is a liquid lithium-ion electrolyte or a polymer lithium-ion electrolyte.

8. The battery pack of claim 1, wherein said large format prismatic lithium-ion cell has a footprint of from 4×4 inches to 24×24 square inches.

9. The battery pack of claim 1, wherein said large format prismatic lithium-ion cell has a thickness of from about 1 mm to about 10 mm.

10. The battery pack of claim 1, wherein said large format prismatic lithium-ion cell has a specific energy of greater than 210 Wh/kg.

11. The battery pack of claim 1, wherein said large format prismatic lithium-ion cell has an energy density of at least 500 Wh/L.

12. The battery pack of claim 1, wherein said large format prismatic lithium-ion cell has an energy density of at least 520 Wh/L.

13. A large format prismatic lithium-ion cell comprising (1) at least one positive electrode, (2) at least one negative electrode, (3) an electrolyte, (4) a homogeneous microporous membrane which comprises (a) a hot-melt adhesive, (b) an engineering plastics, (c) optionally a tackifier and (d) a filler having an average particle size of less than about 50 μm, and (5) a battery cell case.

14. The large format prismatic lithium-ion cell of claim 13, having a specific energy of at least 200 Wh/kg.

15. The large format prismatic lithium-ion cell of claim 13, having a specific energy density of at least 210 wh/kg.

16. The large format prismatic lithium-ion cell of claim 13, having a specific energy density of about 220 Wh/kg.

17. The large format prismatic lithium-ion cell of claim 13, having an energy density of at least 500 Wh/L.

18. The large format prismatic lithium-ion cell of claim 13, having an energy density of at least 520 Wh/L.

19. A method of making the large format prismatic lithium-ion cell of claim 1 comprising the steps of (a) assembling cell by sandwiching at least a separator membrane between at least a positive electrode and at least a negative electrode, (b) binding separator membranes onto electrodes by pressing under a pressure of 50-250 psi at a temperature from 80-100° C. and for about 1-10 minutes, (c) packaging the assembled cell into a battery case, (d) injecting an electrolyte into the battery cell case.
